(19) United States
(12) Patent Application Publication
(10) Pub. No.: US 2022/0019185 A1
(43) Pub. Date: Jan. 20, 2022

(54) METHOD FOR TICKET GENERATION BASED ON ANOMALIES IN A PLURALITY OF DEVICES INSTALLED IN FACILITY

(71) Applicant: Facilio Inc., Lewes, DE (US)

(72) Inventors: Prabhu RAMACHANDRAN, Chennai (IN); Yogendrababu VENKATAPATHY, Chennai (IN); Rajavel SUBRAMANIAN, Chennai (IN); Shivaraj SELVANATHAN, Chennai (IN)

(73) Assignee: Facilio Inc., Lewes, DE (US)

(21) Appl. No.: 16/932,608

(22) Filed: Jul. 17, 2020

(51) Int. Cl. G05B 19/042; G06N 20/00; G01M 99/00

(52) U.S. Cl. CPC G05B 19/042; G05B 2219/25011; G01M 99/00; G06N 20/00

(57) ABSTRACT

The present disclosure provides a system for ticket generation based on anomalies in equipment installed in a facility. An anomaly recognition engine receives a first-set of data from a facility management system. The anomaly recognition engine analyses the first-set of data associated with a plurality of devices. In addition, the anomaly recognition engine detects one or more anomalies in at least one device of the plurality of devices based on the analysis of the first-set of data. Further, a ticket generation module generates a ticket in an event of detection of the one or more anomalies in the at least one device of the plurality of devices associated with the facility. Furthermore, the ticket generation module prioritises the one or more tickets based on the severity of the one or more anomalies.

### TECHNICAL FIELD

The present disclosure relates to the field of building management systems and, in particular, relates to a method for ticket generation based on anomalies in at least one device of a plurality of devices installed in a facility.

### INTRODUCTION

With the advent in technological advancements over the past few decades, there has been an exponential rise in the number of large facilities. These facilities are big residential complexes, commercial offices, shopping centres and the like. These facilities include a facility management system configured to manage, monitor, and control various sensors and equipment installed in or around the facility or facility area. The facility management system may include a HVAC system, a security system, a lighting system, a fire alerting system, a telecom system, and many more systems those are proficient of handling facility functions and devices. The devices in these systems are prone to anomalies. Currently, an anomaly in the system of devices is detected by performing intermittent maintenance check-ups of the devices. Accordingly, the facility management system can generate a ticket for work order based on the severity of the anomaly for a maintenance team to investigate and fix the anomalies. Such prior methods for detecting anomalies and generating ticket can be unproductive and expensive. Further, the prior methods do not prioritize multiple anomalies based on level of severity. In an example, there may be anomalies that may have a serious impact on operations inside a facility if not addressed immediately. Further, additional and repetitive work may be needed to manually validate and identify anomaly as high priority.

In light of the foregoing discussion, there exists a need for a system which overcomes the above-cited drawbacks of conventionally systems.

### SUMMARY

In a first example, a computer-implemented method is provided. The computer-implemented method for ticket generation based on anomalies in at least one device of a plurality of devices installed in a facility. The computer-implemented method includes a first step to receive a first-set of data from a facility management system. The computer-implemented method includes a second step to analyse the first-set of data associated with the plurality of devices. Further, the computer-implemented method includes a third step to detect one or more anomalies in the at least one device of the plurality of devices based on the analysis of the first-set of data. Furthermore, the computer-implemented method includes a fourth step to generate one or more tickets in an event for detection of the one or more anomalies in the at least one device of the plurality of devices associated with the facility. Moreover, the computer-implemented method includes a fifth step to prioritise the one or more tickets based on severity of the one or more anomalies. The facility management system is associated with a plurality of sensors. The plurality of sensors is installed at the plurality of devices. The plurality of devices is installed at different locations in the facility. The first-set of data is received in real time. The analysis of the first-set of data is done by using one or more machine learning algorithms. The one or more tickets includes one or more parameters associated with the one or more anomalies. The one or more tickets are generated in real time. The severity of the one or more anomalies is predicted based on the one or more parameters.

In an embodiment of the present disclosure, the plurality of devices include heating, ventilation, and air conditioning (HVAC), distribution board, transformer, electricity meter, water meter, gas meter, escalators, boiler unit, direct generation system, transmission system, fire detection system, circuit breaker, elevators, circuit disconnects, junction boxes and electric switchgear.

In an embodiment of the present disclosure, the first-set of data includes usage time of device, device behaviour, device output, device efficiency, device anomaly history, lighting settings, air pressure data, air flow data, temperature, humidity, and air quality index.

In an embodiment of the present disclosure, the one or more parameters include facility location, faulty device placement, anomaly type, mean time to repair, required skills and required device.

In an embodiment of the present disclosure, the one or more anomalies include high electricity consumption, low electricity consumption, unusual water consumption, unusual gas consumption, short circuit fault, device failure, symmetrical fault, unsymmetrical fault, temperature fault, unusual pressure, unusual air flow, unusual humidity, device efficiency variations, unusual device noise, circuit overload and lighting fault.

In an embodiment of the present disclosure, the plurality of sensors include dynamic pressure sensor, smoke sensor, infrared sensor, humidity sensor, temperature sensor, occupancy sensor, duct sensor, heating ventilation and air conditioning sensor, vibration sensor and ultrasonic sensor.

In an embodiment of the present disclosure, the computer-implemented method compares present device behaviour with pre-defined device behaviour of each of the plurality of devices installed in the facility. In addition, the comparison is done in real time.

In an embodiment of the present disclosure, the computer-implemented method compares the one or more anomalies in each of the plurality of devices with pre-defined allowable threshold. In addition, the pre-defined allowable threshold is lower tolerance limit and upper tolerance limit of the one or more anomalies. Further, the computer-implemented method modifies the pre-defined allowable threshold based on potential solution of the one or more anomalies in real time.

In an embodiment of the present disclosure, the computer-implemented method identifies facility location, fault location, anomaly type, mean time to repair, required device and required skills. In addition, identification is done in real time.

In an embodiment of the present disclosure, the computer-implemented method sends an alert to a user on media devices. In addition, the alert is sent to inform the user about the one or more tickets and the one or more anomalies in each of the plurality of devices.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for ticket generation based on anomalies in at least one device of a plurality of devices installed in a facility. The computer system includes a first step to receive a first-set of data from a facility management system. The computer system includes a second step to analyse the first-set of data associated with the plurality of devices. Further, the computer system includes a third step to detect one or more anomalies in the at least one device of the plurality of devices based on the analysis of the first-set of data. Furthermore, the computer system includes a fourth step to generate one or more tickets in an event for detection of the one or more anomalies in each of the plurality of devices associated with the facility. Moreover, the computer system includes a fifth step to prioritise the one or more tickets based on severity of the one or more anomalies. The facility management system is associated with a plurality of sensors. The plurality of sensors is installed at the plurality of devices. The plurality of devices is installed at different locations in the facility. The first-set of data is received in real time. The analysis of the first-set of data is done by using one or more machine learning algorithms. The one or more tickets includes one or more parameters associated with the one or more anomalies. The one or more tickets are generated in real time. The severity of the one or more anomalies is predicted based on the one or more parameters.

In a third example, a non-transitory computer-readable storage medium is provided. The non-transitory computer-readable storage medium encodes computer executable instructions. The computer executable instructions are executed by at least one processor to perform a method for ticket generation based on anomalies in at least one device of a plurality of devices installed in a facility. The method includes a first step to receive a first-set of data from a facility management system. The method includes a second step to analyse the first-set of data associated with the plurality of devices. Further, the method includes a third step to detect one or more anomalies in the at least one device of the plurality of devices based on the analysis of the first-set of data. Furthermore, the method includes a fourth step to generate one or more tickets in an event for detection of the one or more anomalies in the at least one device of the plurality of devices associated with the facility. Moreover, the method includes a fifth step to prioritise the one or more tickets based on severity of the one or more anomalies. The facility management system is associated with a plurality of sensors. The plurality of sensors is installed at the plurality of devices. The plurality of devices is installed at different locations in the facility. The first-set of data is received in real time. The analysis of the first-set of data is done by using one or more machine learning algorithms. The one or more tickets includes one or more parameters associated with the one or more anomalies. The one or more tickets are generated in real time. The severity of the one or more anomalies is predicted based on the one or more parameters.

### BRIEF DESCRIPTION OF THE FIGURES

Having thus described the invention in general terms, references will now be made to the accompanying figures, wherein:

FIG. 1 illustrates an interactive computing environment for automatic ticket generation in an event of anomaly detection in at least one device of a plurality of devices installed in a facility in real time, in accordance with various embodiments of the present disclosure;

FIG. 2 illustrates a flowchart of the method for automatic ticket generation in the event of anomaly detection in the at least one device of the plurality of devices installed in the facility in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

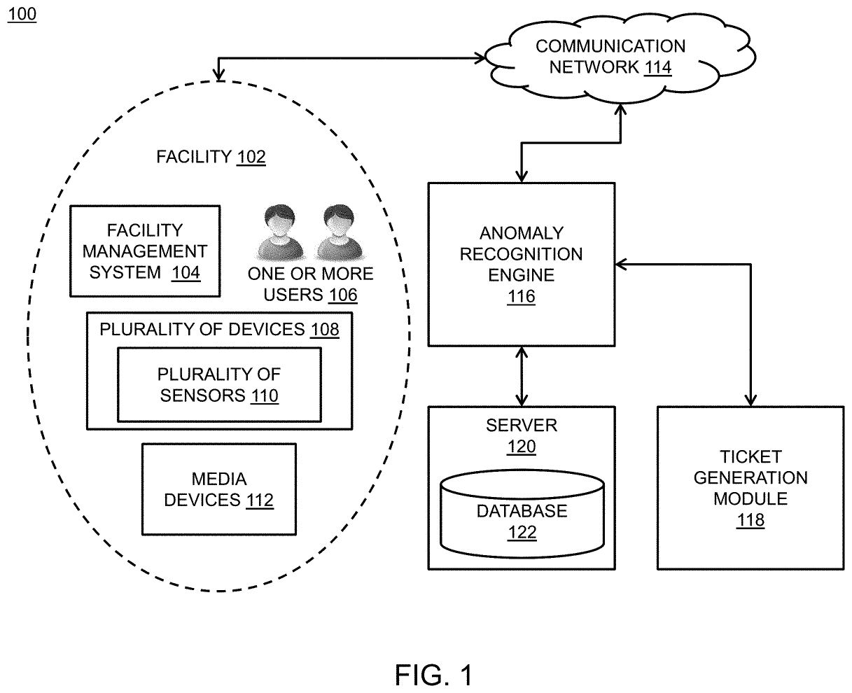

FIG. 1 illustrates an interactive computing environment 100 for automatic ticket generation in an event of anomaly detection in at least one device of a plurality of devices 108 installed in a facility 102 in real time, in accordance with various embodiments of the present disclosure. The interactive computing environment 100 shows a relationship between various entities involved in detection of one or more anomalies in the at least one device of the plurality of devices 108 installed in the facility 102. In addition, the interactive computing environment 100 shows a relationship between various entities involved in the generation of one or more tickets of the one or more anomalies detected by an anomaly recognition engine 116.

The interactive computing environment 100 includes the facility 102, a facility management system 104, a one or more users 106, the plurality of devices 108, a plurality of sensors 110 and media devices 112. In addition, the interactive computing environment 100 includes communication network 114, the anomaly recognition engine 116, a ticket generation module 118, a server 120 and a database 122. The above-stated elements of the interactive computing environment 100 operate coherently and synchronously. The facility management system 104 manages, monitors, and controls various functionality of the plurality of devices 108 installed in the facility 102.

The interactive computing environment 100 includes the facility 102. In general, facility referred to as a building, property, residence or event space that is provided for any occasion, event or for personal use. In an embodiment of the present disclosure, the facility 102 is any building where people come for events. In another embodiment of the present disclosure, the facility 102 is any place where various equipment is installed and working simultaneously to condition the place. In yet another embodiment of the present disclosure, the facility 102 is any place where the facility management system 104 is installed. In yet another embodiment of the present disclosure, the facility 102 is any place where the anomaly recognition engine 116 is installed. In an example, the facility 102 can be booked for marriage function, birthday party, corporate events, and the like. The interactive computing environment 100 includes the facility management system 104. The facility management system 104 facilitates the one or more users 106 to monitor and control various functionality of the plurality of devices 108 installed in the facility 102 in real time. In an embodiment of the present disclosure, the facility management system 104 is accessed through a web browser. In another embodiment of the present disclosure, the facility management system 104 is accessed through a widget, API, web applets and the like. In an example, the web-browser includes but may not be limited to Opera, Mozilla Firefox, Google Chrome, Internet Explorer, Microsoft Edge, Safari and UC Browser. Further, the web browser runs on any version of the respective web browser of the above-mentioned web browsers.

In addition, the facility management system 104 performs computing operations based on a suitable operating system installed inside the facility management system 104. In general, the operating system is system software that manages computer hardware and software resources and provides common services for computer programs. In addition, the operating system acts as an interface for software installed inside the facility management system 104 to interact with hardware components of the facility management system 104. In an embodiment of the present disclosure, the operating system installed inside the facility management system 104 is a mobile operating system. In an embodiment of the present disclosure, the facility management system 104 performs computing operations based on any suitable operating system designed for portable the facility management system 104. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the facility management system 104 operates on any version of a particular operating system of above-mentioned operating systems.

In another embodiment of the present disclosure, the facility management system 104 performs computing operations based on any suitable operating system designed for controlling and managing the plurality of devices 108 and the plurality of sensors 110. In an example, the operating system installed inside the facility management system 104 is Windows from Microsoft. In another example, the operating system installed inside the facility management system 104 is Mac from Apple. In yet another example, the operating system installed inside the facility management system 104 is a Linux based operating system. In yet another example, the operating system installed inside the facility management system 104 may be one of UNIX, Kali Linux, and the like. However, the operating system is not limited to above mentioned operating systems.

In an embodiment of the present disclosure, the facility management system 104 operates on any version of Windows operating system. In another embodiment of the present disclosure, the facility management system 104 operates on any version of Mac operating system. In another embodiment of the present disclosure, the facility management system 104 operates on any version of the Linux operating system. In yet another embodiment of the present disclosure, the facility management system 104 operates on any version of a particular operating system of the above-mentioned operating systems.

The interactive computing environment 100 is associated with the one or more users 106. The one or more users 106 is present inside the facility 102. The one or more users 106 includes one or more human operators, one or more human worker, one or more occupants, one or more data managers, one or more visitors and the like. In an example, the one or more human operators monitor and regulate facility management system 104. In another example, the one or more human workers clean, sweep and repair the plurality of devices 108. In yet another example, the one or more occupants include managers, attendants, assistants, clerk, security staff and the like. In yet another example, the visitors are civilians present for a specific period of time. In an embodiment of the present disclosure, the one or more users 106 is any person who wants to view or manage the plurality of devices 108 and the plurality of sensors 110. In another embodiment of the present disclosure, the one or more users 106 is any person who has the authority to manage the plurality of devices 108 and the plurality of sensors 110. In yet another embodiment of the present disclosure, the one or more users 106 is any person from a maintenance team.

In addition, the maintenance team is one or more persons assigned for servicing and maintaining the plurality of devices 108 and the plurality of sensors 110 installed in the facility 102. In yet another embodiment of the present disclosure, the one or more users 106 is any person who wants to know the status of the one or more anomalies detected by the anomaly recognition engine 116. In yet another embodiment of the present disclosure, the one or more users 106 is any person who is managing an event in the facility 102. In yet embodiment of the present disclosure, the one or more users 106 is any person who has the knowledge to operate the anomaly recognition engine 116. In yet embodiment of the present disclosure, the one or more users 106 is any person who operates the anomaly recognition engine 116. In yet embodiment of the present disclosure, the one or more users 106 is any person who operates the ticket generation module 118. In yet another embodiment of the present disclosure, the one or more users 106 may be any person. The one or more users 106 may interact with the anomaly recognition engine 116 and with the ticket generation module 118 directly through the media devices 112. In some cases, the one or more users 106 may interact with the anomaly recognition engine 116 via the media devices 112 through the communication network 114. In this scenario, the communication network 114 may be a global network of computing devices such as the Internet.

The interactive computing environment 100 includes the plurality of devices 108. In addition, the plurality of devices 108 may be related or unrelated to structure and the operations of the facility 102. The plurality of devices 108 includes heating, ventilation, and air conditioning (HVAC), de-humidifiers, escalators, elevators, and boiler unit. Furthermore, the plurality of devices 108 include direct generation system (hereinafter referred as DG system), distribution board, transformer, transmission system, junction boxes, electric switchgear, circuit breaker, and electrical wiring. Moreover, the plurality of devices 108 include fire detection system, electricity meter, water meter, gas meter, circuit disconnects, lighting system, electronic lock system, intercom system, and the like.

The interactive computing environment 100 includes the plurality of sensors 110. In general, sensors are referred to as a device that detects and measures conversion of energy based on physical parameters or processes and converts real-world information into electrical signals. The sensors are usually used to recognize or perceive some of the features of an environment. In an embodiment of the present disclosure, the plurality of sensors 110 are smart sensors installed at various locations on the facility 102. In another embodiment of the present disclosure, the plurality of sensors 110 are installed in the plurality of devices 108. In an example, the plurality of sensors 110 are installed in various rooms in a hotel, dining hall of the hotel, corridors in the hotel, and the like. In yet another embodiment of the present disclosure, the plurality of sensors 110 are IOT based connected sensors. In yet another embodiment of the present disclosure, the plurality of sensors 110 provides ambient parameters. The plurality of sensors 110 includes temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, biometric sensors, and the like. In an example, the plurality of sensors 110 transmit signal to measure temperature, pressure, air flow, voltage, current, electricity consumption, humidity, and the like. In another example, the plurality of sensors 110 transmit signal to measure operational metrics. In addition, the operational metrics includes but may not be limited to mean time to repair (MTTR), mean time between failures (MTBF), expected lifetime of the plurality of devices 108, and expected lifetime of the plurality of sensors 110.

In addition, the plurality of sensors 110 and the plurality of devices 108 generate a first-set of data. In general, sensor data is referred to as the output of a device that detects a particular kind of input from the physical environment and responds. Output can be used to provide information or input to any other system or to direct a process. In an embodiment of the present disclosure, the first-set of data includes but may not be limited to temperature, usage time of device, device behaviour, device output, device efficiency, device anomaly history, lighting settings, air pressure data, humidity, air flow data and air quality index. In addition, the collection of the first-set of data is performed using a method. In an embodiment of the present disclosure, the method involves the digital collection of data for each of the plurality of devices 108. Further, the first set of statistical data is transferred to the one or more data collecting device. Furthermore, each of the one or more data collecting devices is a portable device with an inbuilt application program interface (hereafter “API”). The inbuilt API of each of the one or more data collection device is associated with a camera, a global positioning system, keypad, and the like. In addition, the keypad gathers manual data input from the one or more users 106.

The interactive computing environment 100 includes the media devices 112. In general, media device refers to equipment or device capable of transmitting analog or digital signals through communication wire or remote way. The best case of the media device is a PC modem, which is equipped for sending and getting analog or digital signals to enable PCs to converse with different PCs. In an embodiment of the present disclosure, the media devices 112 includes but may not be limited to a computer, laptop, smart television, PDA, electronic tablet, smartphone, wearable devices, tablet, smartwatch, smart display, gesture-controlled devices, and the like. In an example, the media devices 112 displays, reads, transmits and gives output to the one or more users 106 in real time. In another example, the media devices 112 reads or scans user-defined rules and user inputs in real time. In an embodiment of the present disclosure, the media devices 112 are connected to the facility management system 104 with the facilitation of the media devices 112. In another embodiment of the present disclosure, the media devices 112 are connected to the anomaly recognition engine 116 with the facilitation of the communication network 114.

In addition, communication network refers to channels of communication (networks by which information flows). Small networks, which are used for connection to the subgroup and are usually contained in a piece of equipment. The local area network, or LAN, cable or fiber, is used to connect computer equipment and other terminals distributed in the local area, such as in the college campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In yet another embodiment of the present disclosure, the communication network 114 may be any type of network that provides internet connectivity to the facility management system 104 and the anomaly recognition engine 116. In yet embodiment of the present disclosure, the communication network 114 is a wireless mobile network. In yet embodiment of the present disclosure, the communication network 114 is a wired network with a finite bandwidth. In yet another embodiment of the present disclosure, the communication network 114 is a combination of the wireless and the wired network for optimum throughput of data transmission. In yet another embodiment of the present disclosure, the communication network 114 is an optical fiber high bandwidth network that enables high data rate with negligible connection drops. In yet another embodiment of the present disclosure, the communication network 114 provides medium for the media devices 112 to connect to the facility management system 104 and the anomaly recognition engine 116.

The interactive computing environment 100 includes the anomaly recognition engine 116. The anomaly recognition engine 116 performs various actions upon the plurality of devices 108 and the plurality of sensors 110 and produces the first-set of data during operation. For example, a lighting system, fire alarm system, Heating ventilation and air conditioning, and the like. In an embodiment of the present disclosure, the anomaly recognition engine 116 categorizes statistics of the first set of data as the one or more anomalies based on real time statistics and past anomalies data. In an example, the past anomalies data includes the first-set of data of 1 day. In another example, the past anomalies data includes the first-set of data of 1 week. In yet another example, the past anomalies data includes the first-set of data of 1 month. In yet another example, the past anomalies data includes the first-set of data of T1 duration of time. In another embodiment of the present disclosure, the anomaly recognition engine 116 categorizes the statistics of the first set of data as the one or more anomalies based on user configurable rules, pre-defined mathematical values, pre-defined logical functions, pre-defined boolean operators, and the like.

The interactive computing environment 100 includes the server 120. In an embodiment of the present disclosure, the facility management system 104 is associated with the server 120. In another embodiment of the present disclosure, the anomaly recognition engine 116 is associated with the server 120. In yet another embodiment of the present disclosure, the facility management system 104 is installed at the server 120. In yet another embodiment of the present disclosure, the facility management system 104 is installed at a plurality of servers. In general, a server refers to a computer that provides data to other computers. It may serve data to systems on a local area network (LAN) or a wide area network (WAN) over the Internet. Many types of servers exist, including web servers, mail servers, file servers, and the like. Each type of server runs software specific to the purpose of the server. For example, a Web server may run Apache HTTP Server or Microsoft IIS, which both provide access to websites over the Internet. A mail server may run a program like Exim or I Mail, which provides SMTP services for sending and receiving the email. A file server might use Samba or the operating system's built-in file sharing services to share files over a network. While server software is specific to the type of server, the hardware is not as important. In fact, a regular desktop computer can be turned into a server by adding the appropriate software. For example, a computer connected to a home network can be designated as a file server, print server, or both. In another example, the plurality of servers may include a database server, file server, application server and the like. The plurality of servers communicates with each other using the communication network 114. In yet another embodiment of the present disclosure, the facility management system 104 is located in the server 120. In yet another embodiment of the present disclosure, the facility management system 104 is connected with the server 120. In yet another embodiment of the present disclosure, the server 120 is a part of the facility management system 104. In an embodiment of the present disclosure, the server 120 receives data from the database 122.

The interactive computing environment 100 includes the database 122. In general, a database refers to a data structure that stores organized information. Most databases contain multiple tables, which may each include several different fields. For example, a hotel database may include records related to rooms available, invoice records, food menu, staff record, and guest details. Each of these tables would have different fields that are relevant to the information stored in the table. In addition, the database 122 stores the first-set of data in real time.

The anomaly recognition engine 116 receives the first-set of data from the facility management system 104. The facility management system 104 is associated with the plurality of sensors 110 installed at different locations in the facility 102. In another embodiment of the present disclosure, the plurality of sensors 110 are installed inside the plurality of devices 108. In yet another embodiment of the present disclosure, the plurality of sensors 110 are installed outside the plurality of devices 108.

In an embodiment of the present disclosure, the anomaly recognition engine 116 determines whether the plurality of devices 108 and the plurality of sensors 110 are operating in a standard state or in a faulty state. In another embodiment of the present disclosure, the anomaly recognition engine 116 receives the first-set of data and utilizes the first-set of data to determine whether the plurality of devices 108 and the plurality of sensors 110 is operating in the standard state or in the faulty state. In addition, the first-set of data are received in real time. The plurality of devices 108 and the plurality of sensors 110 operate in the faulty state only when there is a problem with the plurality of devices 108 and the plurality of sensors 110. When the plurality of devices 108 and the plurality of sensors 110 are operating in the faulty state, the anomaly recognition engine 116 transmits anomaly statistics to the ticket generation module 118. Furthermore, the ticket generation module 118 generates the one or more tickets in real time.

Further, the anomaly recognition engine 116 analyses the first set of data associated with the plurality of devices 108. The analyses are employed by using one or more machine learning algorithms. In an embodiment of the present disclosure, the one or more machine learning algorithms include but may not be limited to decision tree machine learning algorithm, random forest machine learning algorithm, naive bayes classifier machine learning algorithm, support vector machine learning algorithm, k-nearest neighbors machine learning algorithm, and linear regression machine learning algorithm. Further, the anomaly recognition engine 116 compares present device behaviour with the pre-defined device behaviour of each of the plurality of devices 108 installed in the facility 102. Furthermore, the comparison of the present device behaviour with the pre-defined device behaviour of each of the plurality of devices 108 installed in the facility 102 is done in real time.

Further, the anomaly recognition engine 116 detects the one or more anomalies in at least one device of the plurality of devices 108 based on the analysis of the first-set of data. The detection of the one or more anomalies is done in real time. For example, facility F1 is fitted with parent meter and sub meters for electricity metering. The parent meter is fitted at main power supply. On other hand, the sub meters are fitted at different locations in the facility F1. The arrangement of the main meter and the sub meters facilitates the anomaly recognition engine 116 to diagnose and detect the location of faulty sub meter.

In an embodiment of the present disclosure, the anomaly recognition engine 116 compares the one or more anomalies in each of the plurality of devices 108 with pre-defined allowable threshold. The pre-defined allowable threshold is lower tolerance limit and upper tolerance limit of the one or more anomalies. The anomaly recognition engine 116 can modify the pre-defined allowable threshold based on potential solution of the one or more anomalies in real time. The one or more anomalies include high electricity consumption, low electricity consumption, unusual water consumption, unusual gas consumption, short circuit fault, device failure, symmetrical fault, and unsymmetrical fault. In addition, the one or more anomalies include temperature fault, unusual pressure, unusual air flow, unusual humidity, device efficiency variations, unusual device noise, circuit overload, lighting fault, and the like. In an embodiment of the present disclosure, the ticket generation module 118 generates the one or more tickets in an event for detecting the one or more anomalies in the at least one device of the plurality of devices 108 associated with the facility 102. In addition, the one or more tickets include one or more parameters associated with the one or more anomalies. The one or more tickets are generated in real time. The one or more parameters include facility location, faulty device placement, anomaly type, the mean time to repair (MTTR), the mean time between failures (MTBF), required skills, required device, and the like.

In an embodiment of the present disclosure, the anomaly recognition engine 116 can find potential solution to the one or more anomalies in real time based on the past anomalies data and past records of solution for the one or more anomalies. In another embodiment of the present disclosure, the anomaly recognition engine 116 can execute potential solution for the one or more anomalies in real time based on the past anomalies data and the past records of solution for the one or more anomalies. For example, the anomaly recognition engine 116 receives anomaly alert for drop in pressure than pre-defined threshold limit inside building B1. The anomaly recognition engine 116 can execute one or more commands to get pressure inside the building B1 in pre-defined threshold limit based on the past anomalies data and the past records of solution for the one or more anomalies. In an embodiment of the present disclosure, the anomaly recognition engine 116 predicts spare parts or material required for potential repair of the one or more anomalies based on the past anomalies data and the past records of solution for the one or more anomalies. Further, the ticket generation module 118 raise purchase order for predicted spare parts or material required for potential repair of the one or more anomalies in real time. In an embodiment of the present disclosure, the ticket generation module 118 sends the one or more tickets to a maintenance team. In another embodiment of the present disclosure, the ticket generation module 118 sends the purchase order details to the maintenance team. In general, the maintenance team corresponds to one or more persons assigned for servicing and maintaining the plurality of devices 108 and the plurality of sensors 110 installed in the facility 102.

In another embodiment of the present disclosure, the ticket generation module 118 prioritizes the one or more tickets based on the severity of the one or more anomalies.

The severity of the one or more anomalies are predicted based on the one or more parameters. In an example, in a hotel building, the fire alarm system and the electronic lock system simultaneously shows anomalies, the ticket generation module 118 assigns the fire system anomaly high priority than that of the electronic system anomaly. In yet another embodiment of the present disclosure, the ticket generation module 118 identifies facility location, anomaly location, anomaly type, mean time to repair, required device, required skills, and the like. The identification is done in real time.

In an embodiment of the present disclosure, the ticket generation module 118 sends an alert to the one or more users 106 on the media devices 112. In another embodiment of the present disclosure, the alert is sent to inform the one or more users 106 about the one or more tickets in each of the plurality of devices 108 in real time. In yet another embodiment of the present disclosure, the alert is sent to inform the one or more users 106 about the one or more anomalies in each of the plurality of devices 108 in real time. In an embodiment of the present disclosure, the one or more users 106 can configure pre-defined parameters of the plurality of devices 108 and the plurality of sensors 110. In an example, user U1 receives anomaly notification when building B2 temperature is more than pre-defined threshold limit. The user U1 can configure pre-defined temperature settings to get temperature of the building B2 in the pre-defined threshold limit.

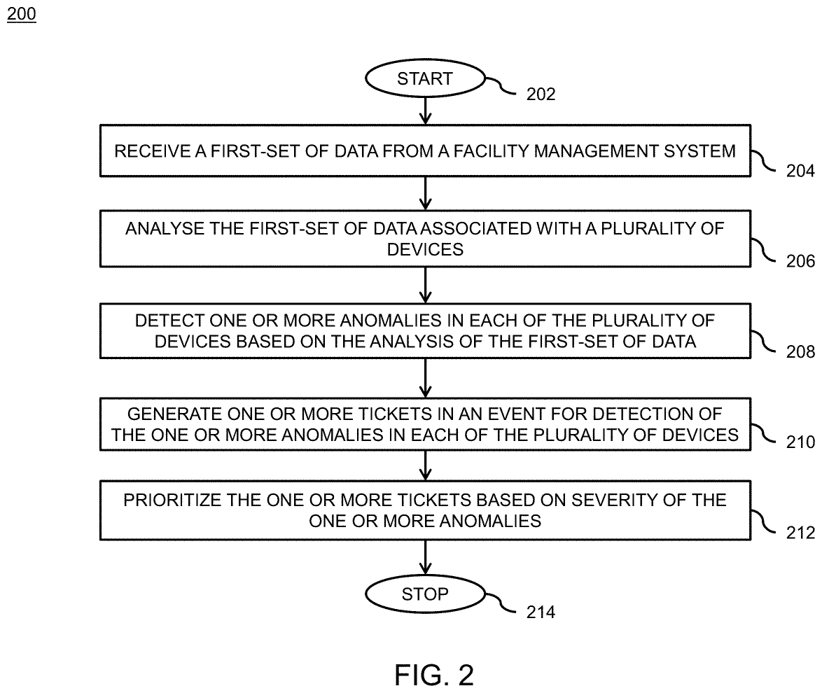

FIG. 2 illustrates a flowchart 200 of the method for automatic ticket generation in the event of anomaly detection in the at least one device of the plurality of devices 108 installed in the facility 102 in real time, in accordance with various embodiments of the present disclosure. It may be noted that in order to explain the method steps of the flowchart 200, references will be made to the elements explained in FIG. 1. The flowchart 200 starts at step 202. At step 204, the anomaly recognition engine 116 receives the first-set of data from the facility management system 104. At step 206, the anomaly recognition engine 116 analyses the first-set of data associated with the plurality of devices 108. At step 208, the anomaly recognition engine 116 detects the one or more anomalies in the at least one device of the plurality of devices 108 based on the analysis of the first-set of data. At step 210, the ticket generation module 118 associated with the anomaly recognition engine 116 generates the one or more tickets in the event for detection of the one or more anomalies in the at least one device of the plurality of devices 108 associated with the facility 102. At step 212, the ticket generation module 118 prioritizes the one or more tickets based on severity of the one or more anomalies. The flow chart 200 terminates at step 214.

It may be noted that the flowchart 200 is explained to have above stated process steps; however, those skilled in the art would appreciate that the flowchart 200 may have more/less number of process steps which may enable all the above stated embodiments of the present disclosure.

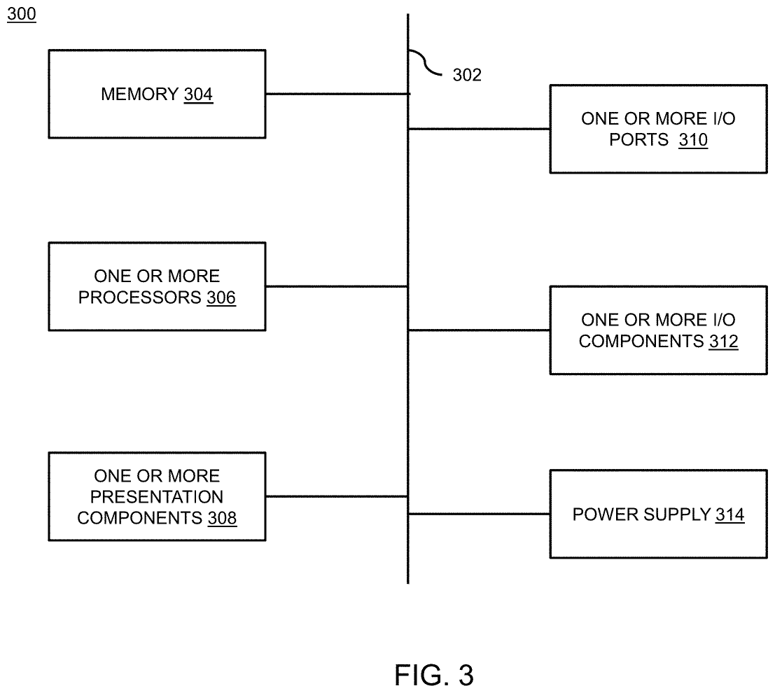

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device”.

The computing device 300 typically includes a variety of computer-readable media. The computer-readable media can be any available media that can be accessed by the computing device 300 and includes both volatile and non-volatile media, removable and non-removable media. By way of example, and not limitation, the computer-readable media may comprise computer storage media and communication media. The computer storage media includes volatile and non-volatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300.

In addition, the communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or non-volatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to the one or more users 106 or another device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for ticket generation based on anomaly in at least one device of a plurality of devices installed in a facility, the computer-implemented method comprising:
receiving, at an anomaly recognition engine with a processor, a first-set of data from a facility management system, wherein the facility management system is associated with a plurality of sensors, wherein the plurality of sensors are installed at the plurality of devices, wherein the plurality of devices are installed at different locations in the facility, wherein the first-set of data is received in real time;
analyzing, at the anomaly recognition engine with the processor, the first-set of data associated with the plurality of devices, wherein the analysis of the first-set of data is done by using one or more machine learning algorithms;
detecting, at the anomaly recognition engine with the processor, one or more anomalies in the at least one device of the plurality of devices based on the analysis of the first-set of data, wherein the detection is done in real time;
generating, at a ticket generation module with a processor associated with the anomaly recognition engine, one or more tickets in an event of the detection of the one or more anomalies in the at least one device of the plurality of devices associated with the facility, wherein the one or more tickets comprising one or more parameters associated with the one or more anomalies, wherein the one or more tickets are generated in real time; and
prioritizing, at the ticket generation module with the processor, the one or more tickets based on severity of the one or more anomalies, wherein the severity of the one or more anomalies are predicted based on the one or more parameters.

2. The computer-implemented method as recited in claim 1, wherein the plurality of devices comprising heating, ventilation, and air conditioning (HVAC), de-humidifiers, escalators, elevators, boiler unit, direct generation system (DG system), distribution board, transformer, transmission system, junction boxes, electric switchgear, circuit breaker, electrical wiring, fire detection system, electricity meter, water meter, gas meter, circuit disconnects, lighting system, electronic lock system, and intercom system.

3. The computer-implemented method as recited in claim 1, wherein the first-set of data comprising usage time of device, device behaviour, device output, device efficiency, device anomaly history, lighting settings, air pressure data, air flow data, temperature, humidity, and air quality index.

4. The computer-implemented method as recited in claim 1, wherein the one or more parameters comprising facility location, faulty device placement, anomaly type, mean time to repair, required skills and required device.

5. The computer-implemented method as recited in claim 1, wherein the one or more anomalies comprising high electricity consumption, low electricity consumption, unusual water consumption, unusual gas consumption, short circuit fault, device failure, symmetrical fault, unsymmetrical fault, temperature fault, unusual pressure, unusual air flow, unusual humidity, device efficiency variations, unusual device noise, circuit overload and lighting fault.

6. The computer-implemented method as recited in claim 1, wherein the plurality of sensors comprising a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

7. The computer-implemented method as recited in claim 1, further comprising comparing, at the anomaly recognition engine with the processor, present device behaviour with pre-defined device behaviour of each of the plurality of devices installed in the facility, wherein the comparison is done in real time.

8. The computer-implemented method as recited in claim 1, further comprising comparing, at the anomaly recognition engine with the processor, the one or more anomalies in the at least one device of the plurality of devices with pre-defined allowable threshold, wherein the pre-defined allowable threshold is lower tolerance limit and upper tolerance limit of the one or more anomalies, wherein the anomaly recognition engine modifies the pre-defined allowable threshold based on potential solution of the one or more anomalies in real time.

9. The computer-implemented method as recited in claim 1, further comprising identifying, at the ticket generation module with the processor, facility location, fault location, anomaly type, mean time to repair, required device and required skills, wherein the identification is done in real time.

10. The computer-implemented method as recited in claim 1, further comprising sending, at the ticket generation module with the processor, an alert to a user on media devices, wherein the alert is sent to inform the user about the one or more tickets and the one or more anomalies in the at least one device of the plurality of devices.

11. A computer system comprising:
one or more processors; and
a memory coupled to the one or more processors, the memory for storing instructions which, when executed by the one or more processors, cause the one or more processors to perform a method for ticket generation based on anomaly in at least one device of a plurality of devices installed in a facility, the method comprising:
receiving, at an anomaly recognition engine, a first-set of data from a facility management system, wherein the facility management system is associated with a plurality of sensors, wherein the plurality of sensors are installed at the plurality of devices, wherein the plurality of devices are installed at different locations in the facility, wherein the first-set of data is received in real time;
analyzing, at the anomaly recognition engine, the first-set of data associated with the plurality of devices, wherein the analysis of the first-set of data is done by using one or more machine learning algorithms;
detecting, at the anomaly recognition engine, one or more anomalies in the at least one device of the plurality of devices based on the analysis of the first-set of data, wherein the detection is done in real time;
generating, at a ticket generation module associated with the anomaly recognition engine, one or more tickets in an event for detection of the one or more anomalies in the at least one device of the plurality of devices associated with the facility, wherein the one or more tickets comprising one or more parameters associated with the one or more anomalies, wherein the one or more tickets are generated in real time; and
prioritizing, at the ticket generation module, the one or more tickets based on severity of the one or more anomalies, wherein the severity of the one or more anomalies are predicted based on the one or more parameters.

12. The computer system as recited in claim 11, wherein the plurality of devices comprising heating, ventilation, and air conditioning (HVAC), de-humidifiers, escalators, elevators, boiler unit, direct generation system (DG system), distribution board, transformer, transmission system, junction boxes, electric switchgear, circuit breaker, electrical wiring, fire detection system, electricity meter, water meter, gas meter, circuit disconnects, lighting system, electronic lock system, and intercom system.

13. The computer system as recited in claim 11, wherein the first-set of data comprising usage time of device, device behaviour, device output, device efficiency, device anomaly history, lighting settings, air pressure data, air flow data, temperature, humidity, and air quality index.

14. The computer system as recited in claim 11, wherein the one or more parameters comprising facility location, faulty device placement, anomaly type, mean time to repair, required skills and required device.

15. The computer system as recited in claim 11, wherein the one or more anomalies comprising high electricity consumption, low electricity consumption, unusual water consumption, unusual gas consumption, short circuit fault, device failure, symmetrical fault, unsymmetrical fault, temperature fault, unusual pressure, unusual air flow, unusual humidity, device efficiency variations, unusual device noise, circuit overload and lighting fault.

16. The computer system as recited in claim 11, wherein the plurality of sensors comprising a temperature sensor, humidity sensor, dynamic pressure sensor, smoke sensor, infrared sensor, occupancy sensor, duct sensor, sound sensors, vibration sensor, ultrasonic sensor, touch sensors, proximity sensors, IR sensors, light sensors, air quality index sensors, location sensors, alarm sensors, motion sensors, and biometric sensors.

17. The computer system as recited in claim 11, further comprising comparing, at the anomaly recognition engine, present device behaviour with pre-defined device behaviour of each of the plurality of devices installed in the facility, wherein the comparison is done in real time.

18. A non-transitory computer-readable storage medium encoding computer executable instructions that, when executed by at least one processor, performs a method for ticket generation based on anomaly in at least one device of a plurality of devices installed in a facility, the method comprising:
receiving, at a computing device, a first-set of data from a facility management system, wherein the facility management system is associated with a plurality of sensors, wherein the plurality of sensors are installed at the plurality of devices, wherein the plurality of devices are installed at different locations in the facility, wherein the first-set of data is received in real time;
analysing, at the computing device, the first-set of data associated with the plurality of devices, wherein the analysis of the first-set of data is done by using one or more machine learning algorithms;
detecting, at the computing device, one or more anomalies in the at least one device of the plurality of devices based on the analysis of the first-set of data, wherein the detection is done in real time;
generating, at the computing device associated with the anomaly recognition engine, one or more tickets in an event for detection of the one or more anomalies in the at least one device of the plurality of devices associated with the facility, wherein the one or more tickets comprising one or more parameters associated with the one or more anomalies, wherein the one or more tickets are generated in real time; and
prioritizing, at the computing device, the one or more tickets based on severity of the one or more anomalies, wherein the severity of the one or more anomalies are predicted based on the one or more parameters.

19. The non-transitory computer-readable storage medium as recited in claim 18, wherein the plurality of devices comprising heating, ventilation, and air conditioning (HVAC), de-humidifiers, escalators, elevators, boiler unit, direct generation system (DG system), distribution board, transformer, transmission system, junction boxes, electric switchgear, circuit breaker, electrical wiring, fire detection system, electricity meter, water meter, gas meter, circuit disconnects, lighting system, electronic lock system, and intercom system.

20. The non-transitory computer-readable storage medium as recited in claim 18, wherein the first-set of data comprising usage time of device, device behaviour, device output, device efficiency, device anomaly history, lighting settings, air pressure data, air flow data, temperature, humidity, and air quality index.
